(19) United States
(12) Patent Application Publication
(10) Pub. No.: US 2025/0037001 A1
(43) Pub. Date: Jan. 30, 2025

(54) SYSTEMS AND METHODS FOR QUADRATIC UNCONSTRAINED BINARY OPTIMIZATION (QUBO) TRANSFORMATION

(71) Applicant: HSBC Group Management Services Limited, London (GB)

(72) Inventors: Megan Charrisze Giron, London (GB); Georgios Korpas, Singapore (SG); Waqas Parvaiz, London (GB); Prashant Malik, London (GB); Johannes Aspman, Prague (CZ)

(73) Assignee: HSBC GROUP MANAGEMENT SERVICES LIMITED, London (GB)

(21) Appl. No.: 18/914,855

(22) Filed: Oct. 14, 2024

(30) Foreign Application Priority Data
Oct. 4, 2024 (GR) 20240100697

(51) Int. Cl. G06N 10/60; G06F 8/41

(52) U.S. Cl. CPC G06N 10/60; G06F 8/443

(57) ABSTRACT

Computer devices, systems and methods for transforming converting and evaluating high complexity computer science optimization problems using quantum and quantum inspired data transformation approaches and corresponding computer data structures are proposed, useful in specific situations, where computational complexity at scale prohibits alternative approaches, the approaches to solving the transformed problems yielding acceptable accuracy output despite a technical tradeoff in potential loss in accuracy. The transformed computer problem can then be solved using specialized quantum or quantum inspired computing architectures. The optimization problem outputs can be converted into specific data messages routed for automatically invoking downstream data processes and data subroutines.

### FIELD

Embodiments of the present disclosure relate to the field of computer science and computer architectures for programming optimization using transformations, and more specifically, embodiments relate to devices, systems and methods for improved combinatorial optimization using mixed-integer linear programming (MILP) formulation and quadratic unconstrained binary optimization (QUBO) transformation approaches required for addressing challenging, high-complexity computing applications with large instances using quantum or quantum-inspired computing approaches.

### INTRODUCTION

Combinatorial optimization refers to a type of optimization in computer science that consists of finding an optimal object from a finite set of objects, where the set of feasible solutions is discrete or can be reduced to a discrete set. Combinatorial optimization problems can become intractable as complexity rises, meaning exhaustive search through the problem space is infeasible, and so specialized approaches are required to traverse the problem space for an optimal solution.

A computer science problem that is tractable at a low level of dimensionality, for example, can have a complexity level that scales non-linearly as the number of dimensionality grows. If the complexity scales such that the problem becomes intractable, existing approaches no longer become feasible and alternative approaches must be considered. Essentially, the amount of computing resources required to solve a computer science problem using an initial approach scales rapidly beyond available computing resources, and thus the initial approach is not practically usable anymore.

An applied objective of combinatorial optimization is to allocate objects to some number of categories/containers while minimizing the cost of some particular measure in the solution that satisfies the problem (e.g., minimize the number of edges when finding a path in a graph). This can result in a large scale optimization problem, especially as the problem space grows in size. In practical examples, this can include a growth of the number of objects being analyzed, a number of instances, a number of nodes.

Accordingly, combinatorial optimization presents a difficult computer science problem when the problem complexity scales up significantly and exponentially as the number of potential objects to be allocated scales. Optimized object allocation is a non-trivial combinatorial optimization computer science problem, and significant computing resources are devoted to identifying optimal allocations from a large potential set of combinations of allocations. As existing computing approaches do not scale, alternative approaches must be considered.

### SUMMARY

A technical approach is proposed herein that transforms a mixed-integer linear programming (MILP) formulation and a quadratic unconstrained binary optimization (QUBO) formulation to employ a heuristic optimization for allocating data objects to parties in a hybrid-quantum and noisy intermediate-scale quantum-ready approach for combinatorial optimization problems. Effectively, an approach and corresponding computing systems for performing a domain transformation is being proposed to harness enhanced quantum computing or quantum inspired computing capabilities. The objective is to achieve sufficient performance (i.e., experiments have shown exhibits a loss of performance, but within an acceptable range that is reasonably close) while providing a practical solution that can be used at scale, beyond the complexity limitations of prior approaches. This approach is particularly useful when attempting to solve complex combinatorics problems at high scale.

The transformation approach can be practically implemented in the form of a specialized computer or computational circuit that is specifically adapted for problem transformation. Once the problem is transformed, a quantum or quantum inspired computer architecture can be applied as a solver, generating output data structures that can then be used to establish control signals for invoking data processes in accordance with the output data structures. These control signals, for example, can include application programming interface calls and corresponding data messages generated to control pathfinding, conduct allocation transactions, among others. The output data structure can, for example, be provided in the form of a routing table for routing generated data messages. As a practical non-limiting example, the generated data messages can be used to automatically initiate transactions, automatically causing shifts in allocations between different types of digital assets, for example.

While not specifically limited to the banking sector and financial institutions, in this practical example, the approach can map the optimization variables and constraints on assets and counterparties of a transaction onto an MILP and QUBO formulation to attain an optimized allocation selections of assets to be distributed amongst a portfolio of counterparties in a single automated process rather than in a sequential model. It is important to note that the approach is a computerized estimation, and that the optimized allocation may not be a global optimality, but rather an approximation or optimized relative to a baseline.

Computer devices, systems and methods for converting and evaluating optimization problems using quantum algorithms and corresponding computer data structures are proposed to select optimized allocations of financial assets to satisfy obligations or secure transactions while simultaneously minimizing the cost of collateral required to mitigate the risk associated with a particular transaction or a portfolio of transactions while ensuring sufficient protection for the involved parties.

A combinatorial optimization problem involves matching or proportioning a number of objects and parties in such a way as to optimize for some target (e.g., maximization target, minimization target) with constraints. These types of problems are NP-hard problems to solve as they are non-convex problems because the objects and identifiers are non-continuous values and the types of objects are disjoint from one another. Some variables and constraints of the problem can be continuous (weights) and the nature of the variables and combinatorics of discrete objects makes the problem difficult.

Linear programming algorithms can provide a framework for evaluating combinatorial optimization problems. For example, combinatorial optimization problems are suitable to be implemented using mixed-integer linear program (MILP) solvers (e.g., IBM CPLEX, Gurobi, Mosek), which are the solvers in industrial and academic applications. The success of a combinatorial optimization problem instance or the quality of its solution depends on a clear mapping between the optimization problem itself and the mathematical formulation as well as the precise implementing algorithm. An advantage of using numerical optimization is that the allocation selections can be obtained in a single process, which is in contrast to other proposed models, such as “ranking-based”, “economic-cost”, and “waterfall” models, which are sequential in nature, rather than automated. However, there are several limitations of using MILP solvers to evaluate combinatorial optimization problems, which potentially involve complex nonlinearities and large-scale datasets.

A major technical disadvantage of MILP solvers is that they have exponential worse-case complexity and can take a significant amount of time to solve large-scale complex optimization problems. This issue becomes more serious as complexity increases, to the point where the problem is no longer solvable with practical finite amounts of computing resources. Heuristics may need to be used as part of the optimization when the instance or the complexity of the problem becomes significant.

While having convergence certificates is desirable, the exponential complexity of the MILP solver is often a problem for many combinatorial optimization problem instances that involve a large number of decision variables and constraints as they can either have long solution times or finding a solution may even be infeasible. For example, in combinatorial optimization problem instances relating to banking, the magnitude of the possible combinations of allocations for large institutions would make the selection of transactions for the assets a time-consuming process.

Other previous approaches to solve these computationally challenging problems involve utilizing computers that rely on quantum-mechanical effects for storing and processing information (e.g., IBM's True Spike™ neuromorphic computer was utilized to find approximate solutions for graph partitioning problems, but performance was not adequate). Quantum processors containing qubits which are not advanced enough yet for fault-tolerance or large enough to achieve quantum advantage.

There are three main approaches to follow to approximate better solutions for a variety of NP-hard problem instances. First, a main approach is using variational quantum algorithms (VQAs), such as the quantum approximate optimization algorithm (QAOA), on gate-based quantum computers (e.g., IBM's superconducting quantum computer) with significant (qubit) resources. Second, another main approach is using quantum annealing (QA) on adiabatic quantum computers (quantum annealers) (e.g., D-wave hardware). Third, the last main approach is using quantum-inspired methods that can be understood as using the QUBO formulation of the problem of interest with any approach that ranges from simulated annealing (SA) on high-performance clusters or digital annealing (e.g., Fujitsu's field-programmable gate array (FPGA)-based “quantum-inspired” classical hardware time to solution digital annealing unit (DAU)). Yet another approach is to use Coherent Ising solvers such as a laser processing unit (LPU), and the method described herein can also be adapted for this usage.

The aforementioned three approaches all involve conversion of the original mathematical formulation of the problem from a linear program (LP) formulation to a QUBO problem. The reason lies in the inherent ability of quantum or hybrid approaches to model the Ising model type of systems. For example, an optimization problem can be mapped to the classical Hamiltonian of the Ising model, wherein its ground state encodes the optimum. NP-hard problems can generally admit at least one formulation of the Ising model. Near-term quantum computers and dedicated quantum-inspired hardware may provide a computational or business advantage to institutions in the near term. For the technical problems described herein, the proposed solutions are especially useful when there is a lack of convexity and the problem is thus even more difficult.

Embodiments described herein introduce a hardware agnostic formulation of combinatorial optimization problems that would be suitable with any of the aforementioned approaches. The class of problems that noisy intermediate-scale quantum (NISQ) computers can solve is not a subset of BPP (bounded probabilistic polynomial) problems. However, the heuristic nature of NISQ computers can conceal their applicability, especially when considering problem instances with sizes suitable for high-quality MILP solvers.

A problem instance suitable for MILP solvers is the Knapsack Problem, which involves determining the optimal approach to filling a knapsack of capacity W with the highest possible value from a set of n items that have specific sizes and corresponding values. As an example, the VQA approach can also be used for solving the Knapsack Problem, but there can be a lack of transparent computational advantage in introducing entanglement when VQAs are used. The lack of computational advantage is expected due to the well-known local minima problem that VQAs exhibit and bias in the noise of circuits that implement the VQAs which can unfavorably affect the convergence ratios.

Performance advantages have however been showcased in a variety of applications within the context of digital and QA solutions, tensor networks, and analog and digital (gate-based) quantum computing. For example, the Maximal Independent Set Problem, a NP-hard problem with similar computational complexity to the Knapsack Problem and other NP-hard problems that admit an MILP formulation, has a superlinear quantum speedup, as opposed to classical solutions, when considering very hard graphs.

While classical solvers can solve the optimization problems in a MILP formulation, they are not able to scale enough to handle problems with an even larger lack of convexity (e.g., larger number of objects, larger number of parties, constraints that constrain discrete objects). Using classical solvers for these types of problems results in a large complexity.

Embodiments described herein provide an MILP formulation used as a precursor step for formulating a QUBO version of a combinatorial optimization problem, a suitable format for feeding into quantum and quantum-inspired solvers and performing small-scale simulations of such solvers and comparing the results to that of MILP, which is not suitable for running on quantum-inspired or quantum chipsets. Embodiments described herein provide a QUBO encoding of a combinatorial optimization problem that performs well on small instances and can be extrapolated to implementations on real quantum or quantum-inspired hardware for large instances. The QUBO formulation can also be used to formulate the Knapsack Problem as an example application on a smaller problem instance similar to combinatorial optimization problems.

Embodiments described herein introduce a formulation and approach to solving the combinatorial optimization problems using quantum computing techniques to improve realization of quantum computing advantages in practical applications. However, as described herein, specific technical variant approaches are also proposed, each providing different advantages in different applied scenarios.

Embodiments described herein provide a practical MILP formulation suitable to be mapped to a QUBO and two QUBO formulations, one based on slack variables and one based on unbalanced penalization. The provided approaches represent improved technical formulations of the combinatorial optimization problem for quantum or hybrid solutions.

As described in further detail herein, a number of variant approaches are proposed as well. In particular, a balanced slack variable encoding and unbalanced penalization are proposed, with each approach has different technical characteristics (e.g., strengths and weaknesses). Balanced encoding introduces additional slack variables, which can increase the problem size but allows for exact constraint satisfaction. Unbalanced penalization, on the other hand, does not require extra variables but may lead to approximate constraint satisfaction.

In a variation, the approach includes an initial programming stage for controlling the adaptive encoding strategy. The adaptive encoding strategy chooses the most appropriate technique for each constraint based on the properties of the problem instance at hand, and various steps are described herein. A benefit of this dynamic encoding approach is that it can potentially lead to more compact and better-conditioned QUBOs by selecting the most natural encoding for each constraint. This could improve solution quality and convergence speed compared to using the same encoding for all constraints. It also introduces a new dimension for tuning the QUBO formulation, in addition to the typical approach of adjusting the constraint penalty weights.

Another variant embodiment is directed to using a hybrid classical-quantum approach, whereby a combination of different types of computing platforms are utilized together in concert, in effect, creating a hybrid computing architecture that provides a “warm start” capability. A classical computer system and a quantum/quantum-inspired computing system are used together to benefit from the strengths of both classical and quantum optimization methods used together. The systems are coupled together and operate together.

Classical MILP solvers are highly optimized and can often find very good solutions to large-scale problems in a reasonable amount of time. However, and this is the reason why quantum/quantum-inspired computing is useful is that the classical MILP solvers may struggle to improve upon these solutions due to the complexity of the problem space and/or budget/time constraints imposed by user.

On the other hand, quantum and quantum-inspired solvers, quantum annealing, and digital annealing, are well-suited for exploring complex solution spaces and can potentially find better solutions than classical methods and if given a good initial starting point to converge efficiently they might significantly improve upon. Due to their random nature, a proposed approach is to use a combination of the classical MILP solvers and utilize a system to identify a cross-over point to switch to the new methods using the transformations described herein.

More specifically, the approach can include having a system supervisor controlling problem solving by the MILP solver operating in conjunction with a problem transformer and a QUBO solver, the system supervisor using the classical MILP solver to quickly find a high-quality initial solution, and then convert to QUBO and use that solution as a starting point for a quantum or quantum-inspired solver to further optimize,

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an example block schematic diagram of the combinatorial optimization problem, according to some embodiments.

FIG. 2 is a bar graph displaying an example of optimal allocations of data objects among parties, according to some embodiments.

FIG. 3 is an example graphical representation displaying optimal allocations of different data objects among parties with results determined using different solvers, according to some embodiments.

FIG. 4 is a scatterplot graph displaying example percentage differences, for different solvers, between the total values posted and the required exposures for all the parties, according to some embodiments.

FIG. 5 is a graph displaying performance complexities for different algorithms when being used to solve an example combinatorics optimization problem, according to some embodiments.

FIG. 6 is an example computing system diagram showing an example practical computing system for implementing the system for optimizing allocation of data objects, according to some embodiments.

### DETAILED DESCRIPTION

A methodological technical approach and corresponding computer system is proposed herein that utilizes a mixed-integer linear programming (MILP) formulation and a quadratic unconstrained binary optimization (QUBO) formulation to employ a heuristic optimization algorithm for allocating data objects to parties in a hybrid-quantum and noisy intermediate-scale quantum-ready approach. While not specifically limited to the banking sector and financial institutions, as a practical example, the approach can map the optimization variables and constraints on assets and counterparties of a transaction onto an MILP and QUBO formulation to attain optimal allocation selections of assets to be distributed amongst a portfolio of counterparties in a single automated process rather than in a sequential model.

Computer devices, systems and methods for converting and evaluating optimization problems using quantum algorithms and corresponding computer data structures are proposed to select optimal allocations of financial assets to satisfy obligations or secure transactions while simultaneously minimizing the cost of collateral required to mitigate the risk associated with a particular transaction or a portfolio of transactions while ensuring sufficient protection for the involved parties. The approaches proposed herein assist in improving computing efficiency when computing at a large scale. Essentially, a computer science complexity challenge that arises when scaling at large instance size is overcome through a transformation application proposed herein. While there are technical drawbacks that also arise, it is proposed that a potential loss in performance is an acceptable technical tradeoff.

Embodiments described herein introduce a formulation and approach to solving combinatorial optimization problems using quantum computing techniques to improve realization of quantum advantage in practical applications.

Embodiments described herein provide a realistic MILP formulation suitable to be mapped to a QUBO and two QUBO formulations, one based on slack variables and one based on unbalanced penalization. The provided approaches represent technical formulations of a combinatorial optimization problem for quantum or hybrid solutions. Balanced encoding introduces additional slack variables, which can increase the problem size but allows for exact constraint satisfaction. Unbalanced penalization does not require extra variables but may lead to approximate constraint satisfaction.

In some embodiments, an adaptive encoding strategy can be used to choose the most appropriate technique for each constraint based on the properties of the problem instance at hand. The strategy can start with a constraint analysis. Before encoding the constraints, each constraint can be analyzed to determine its type (equality or inequality), coefficients, and right-hand side value and also look at the structure of the constraint equations and matrix.

Next, a set of heuristics or rules to map constraint properties to encoding choices can be developed. For example, if a constraint has a large right-hand side value relative to the variable coefficients, unbalanced penalization would be preferred to avoid numerical instability. As a contrasting example, if a constraint matrix is highly sparse, balanced encoding with slack variables may be more efficient than dense penalization.

Then, the encoding heuristics can be applied to each constraint to select either balanced or unbalanced encoding. The choice can be made deterministically based on the heuristics (i.e., a strategy) or by using a probabilistic approach to introduce randomness, but this may too unpredictable. For the QUBO formulation, the objective function can then be encoded and constraint encodings can be dynamically-selected into a QUBO matrix. The resulting QUBO would have a customized constraint encoding tailored to the specific problem instance.

An advantage of this dynamic adaptive encoding approach is that it can potentially result in more compact and better-conditioned QUBOs by selecting the most natural encoding for each constraint. This can improve solution quality and convergence speed compared to using the same encoding for all constraints. This encoding approach also introduces a new dimension for tuning the QUBO formulation, in addition to the typical approach of adjusting the constraint penalty weights.

Embodiments described herein formulate a combinatorial optimization problem as an MILP and, subsequently, reformulate it as a QUBO. Embodiments described herein establish an approach to solving the combinatorial optimization problem by algorithmically reformulating the problem and its implementation, which could be implemented on sufficiently powerful hardware. Consequently, hybrid solver emulators can be employed to run a set of small-scale problems to heuristically identify the most appropriate formulation of the combinatorial optimization problem.

The approaches proposed herein can be used to address optimization problems, and an applied use case can include a mechanism for controlling a backend computer system in making collateral optimization decisions in financial risk scenarios. The backend computer system can receive optimization inputs that are used to control automated or semi-automated actions where downstream computing subroutines modify allocations by sending data messages representing transactions to shift balances to shift allocations. These can include automatically generated trade orders that are algorithmically generated and sent by the system to automatically rebalance in accordance with a routing or collateral optimized holding table data structure that is generated by the solver system.

Collateral optimization refers to the systematic allocation of financial assets to satisfy obligations or secure transactions while simultaneously minimizing costs and optimizing the usage of available resources. This involves assessing the number of characteristics, such as the cost of funding and quality of the underlying assets to ascertain the optimal collateral quantity to be posted to cover exposure arising from a given transaction or a set of transactions. For example, in order to mitigate the risk of a borrower defaulting on a loan, it is necessary for the borrower to furnish collateral in the form of stocks, bonds, cash, or other assets to offset any outstanding exposure.

One of the common objectives of collateral optimization is to minimize the cost of collateral required to mitigate the risk associated with a particular transaction or a portfolio of transactions while ensuring sufficient protection for the involved parties. This often results in a large-scale combinatorial optimization problem.

Collateral optimization (ColOpt) is computationally complex and presents a difficult computational problem as the problem complexity scales up significantly and exponentially as the number of potential asset allocations scales. Optimized asset allocation is a non-trivial combinatorial optimization computer science problem, and significant computing resources are devoted to identifying optimal allocations from a large potential set of combinations of allocations.

In some embodiments, in the context of a financial transaction, wherein one party lends assets to another, the lender assumes a credit risk arising from the possibility that the counterparty may default on its obligations. For example, this risk can arise in derivatives' transactions where the party “in-the-money” is expose is exposed to the party “out-of-the-money”.

To mitigate this risk, the borrower can utilize collateralization, which involves the borrower being required to provide low-risk securities (e.g., cash, bonds, equities) to the lender for the duration of the transaction. Collateralization servers as a form of security against loan defaults as the lender can seize the assets to offset any losses resulting from default. The value of the collateral received is expected to be commensurate with the outstanding exposure, in order to effectively counter balance the outstanding risk.

In practice, a bilateral contract or schedule is often formed for the parties to agree on the terms under which securities can be considered collateral, the process of evaluating the value of these assets, and other regulations. The relevant party may then accordingly select the assets they post to the counterparty. For large financial institutions (e.g., banks), there may be a pool of numerous assets to choose from which need to be distributed amongst a portfolio of various counterparties (e.g., other banks, hedge funds, central banks, etc.). Each asset has an associate opportunity cost, which is a measure of how valuable the asset would be if it were used for another purposes, as well as a cost related to the risk of posting to a particular counterparty amongst other administrative costs. Large financial institutions must, therefore, carefully consider the choice of transactions to reduce these costs.

Poor collateral management can have significant consequences. Collateralization of high-risk securities can lead to financial crises and bankruptcy of large financial institutions. Although previous approaches and research have considered the problem of collateral optimization (ColOpt) and how collateral can be better managed, the prior art is generally centered on financial theories, such as risk aversion and its global financial impact. Due to the competitive advantage that ColOpt strategies offer to financial institutions, the prior art does not disclose a comprehensive approach describing the crucial aspect of collateral management of developing an automated process that selects optimal allocations.

As an example scenario, there can be a financial institution that has a collection (or inventory) of assets, indicated by l, which must be allocated among a set of accounts or parties, indicated by A. An asset and a party can be referred to using the indices i and j, respectively. The total number of assets and parties is represented by n and m, respectively.

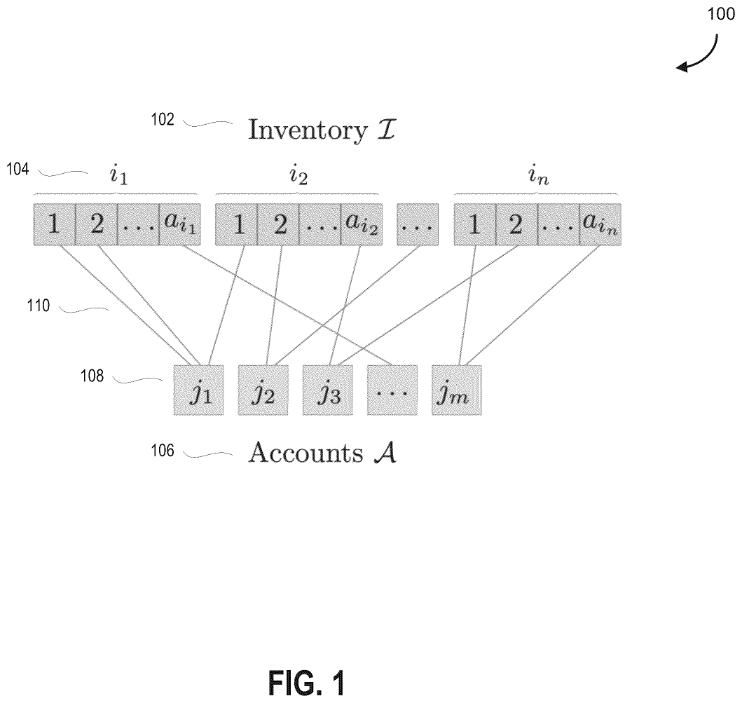

FIG. 1 is an example block schematic diagram of the collateral optimization ColOpt problem, according to some embodiments. As shown in FIG. 1, the ColOpt problem can be formulated as a bipartite matching problem. The bipartite graph 100 can be created with two sets of nodes: one set representing the inventory of assets/102, comprising a number of assets/104, and the other set representing the set of accounts A 106, comprising a number of accounts j 108. The edges 110 between these nodes represent potential allocations of assets to accounts, with weights on these edges representing the suitability, cost, or value of the allocation. The edges 110 are multi-directed and must satisfy certain constraints. To model the constraints of ColOpt, the bipartite graph 100 can be modified accordingly.

While financial assets are described in the example herein, they are provided as examples of an optimization problem that yields a difficult computational problem where complexity has scaled beyond the capabilities of a naïve approach.

In the context of utilizing stocks as collateral, a financial institution may need to require the enforcement of an upper limit regarding the number of shares that can be allocated. To implement this constraint, each asset iₖ ∈I, where I=i₁, i₂, . . . , iₙ, can be subdivided into a maximum quantity denoted by at, representing a constraint on the maximum quantity of asset/104 that can be assigned. The quantity of asset iₖ can be converted into a corresponding dollar value by multiplying by a dimension-ful term vᵢ, which can represent the market value (USD) per unit quantity.

Every asset 104 can be linked to a tier, represented as wᵢ ∈[0,1], which acts as a measure of the asset's quality, wherein distinct tiers correspond to various degrees of quality or attractiveness in the context of the ColOpt problem. A higher value of wᵢ represents a higher quality of asset i 104.

When a financial institution borrows from one of its lenders, collateral must be posted to adequately cover “exposure”, which is capital that could be lost in the event of a default. For each account or party j 108, there can be a required exposure (USD) that must be met, indicated by cⱼ.

The duration of a transaction to a particular account/108 can either be short term or long term, indicated by a binary variable dⱼ∈[0,1]. For example, value 1 can be assigned to short-term and 0 for long-term transfers. To reduce the risk of losing posted collateral, the use of high-quality assets for long-term transactions must be minimized while the use of high-quality assets for short-term transactions must be maximized.

Embodiments described herein first formulate the collateral optimization problem ColOpt as an MILP due to MILP solvers generally performing better than heuristic, hybrid, and near-term quantum solvers for smaller scale problems.

Embodiments described herein can initialize a decision variable matrix Q ∈ [symbol] _{≤1}^{n×m}, containing a number of object-party allocation variables as elements, wherein each element Qᵢⱼ is a continuous variable representing an allocation score which indicates a fractional amount of the corresponding object or asset i that is allocated to the corresponding party or account j, wherein the decision variable matrix has a row for each object or asset, and wherein the decision variable matrix has a column for each party or account. The decision variable matrix can be expressed as:

$$Q = ( \begin{matrix}{a}_{11} & ⋯ & {a}_{1 m} \\ ⋮ & ⋱ & ⋮ \\ {a}_{1 n} & ⋯ & {a}_{nm}\end{matrix} ) . \qquad ( 1 )$$

Embodiments described herein can then construct a coefficients matrix Ω to store a number of tiers, wherein the coefficients matrix has a row for each object or asset, wherein the coefficients matrix has a column for each party or account, and wherein each tier is a scalar value indicative of quality of the corresponding object-party allocation variable.

The coefficients matrix can be an intermediate data object generated as part of the transformation process, and can be represented in the form of an array data structure as shown in (1), or other type of data structure. This can be stored and updated as required in computer storage.

The coefficient matrix Ω can update the tiers wᵢ according to the type of account or party j that collateral is being posted towards. Each element of the coefficient matrix Ω can be determined using:

$${Ω}_{ij} = \vert {w}_{i} - {d}_{j} \vert , s . t . {Ω}_{ij} ∈ [ 0 , 1 ] \qquad ( 2 )$$

Embodiments described herein then generate a number of constraint equations corresponding to the constraints in the given optimization problem. For example, to post collateral such that the financial institution meets the exposure for each account, a requirement constraint must be included:

$${\sum }_{i = 1}^{n} {Q}_{ij} {a}_{i} {v}_{i} {H}_{ij} \geq {c}_{j} ∀ j ∈ 𝒜 . \qquad ( 3 )$$

In Equation 3, vᵢ denotes the dollar market value for a single unit of quantity for asset i. Hence, the term on the left-hand side represents the dollar value for the quantity of collateral that is chosen to be allocated, adjusted by a fractional factor Hᵢⱼ, which is referred to as the haircut. Since markets are dynamic, the value of a posted collateral can diverge from its market value over time. If the value drops below the required collateral value, the receiver is at risk. To prevent this, each account owner can evaluate the risk and place a haircut factor to reduce the value of an asset. The haircut is defined as the percentage difference between the market value and its value while used as collateral. For example, a haircut of 10% corresponds to Hᵢⱼ=0.9, meaning that the collateral value is 90% of the original market value.

As another example, there needs to be a constraint to prevent short-selling of the asset. To ensure that the amount of collateral allocated is not more than 100% of the maximum available quantity in inventory, a consistency constraint must be generated:

$${\sum }_{j = 1}^{m} {Q}_{ij} \leq 1 ∀ i ∈ ℐ . \qquad ( 4 )$$

As another example, there needs to be a trivial constraint to ensure Qᵢⱼ does not take negative values:

$${Q}_{ij} \geq 0 ∀ i ∈ ℐ , ∀ j ∈ 𝒜 . \qquad ( 5 )$$

In some embodiments, the ColOpt problem can be formulated as a continuous optimization problem without additional constraints.

In other embodiments, the ColOpt problem can be formulated with additional constraints. For example, there may be limits on the amount of a particular asset i to account or party j, given by Bᵢⱼ. If Bᵢⱼ=0, the allocation is not eligible. This is a one-to-one constraint and has the following mathematical form:

$${Q}_{ij} {a}_{i} \leq {B}_{ij} ∀ i ∈ ℐ , ∀ j ∈ 𝒜 . \qquad ( 6 )$$

As another example, there can be constraints that restrict the allocation of specific groups of assets to a single account, which exhibits a many-to-one relationship. For instance, certain types of assets {i_{X}_{₁}, i_{X}_{₂}, i_{X}_{₃}}, may be subject to restrictions due to their interrelationships (e.g., there exists a parent company X that posts these assets). This constraint can be formalized using the following inequality:

$${\sum }_{i = 1}^{n} {T}_{ig} {Q}_{ij} {a}_{i} \leq {K}_{gj} ∀ g ∈ 𝒢 , ∀ j ∈ 𝒜 . \qquad ( 7 )$$

wherein G represents the set of all groups of assets, the binary variable T_{ig} indicates whether asset i belongs to the group g, and K_{gj} represents the upper bound on the total amount of assets from group g that can be allocated to account or party j.

In some embodiments, assets i can include equity and bonds in addition to cash. An example constraint in such a scenario is that Aᵢⱼαᵢ must take an integer value. Imposing limits on the allocation of assets promotes diversification and reduces the risk borne by the receiver.

Embodiments described herein computationally convert the decision variable matrix and the coefficients matrix into a MILP formulated problem with a linear objective function and the constraint equations. As the instance size and corresponding complexity grows, as noted herein, there will be technical limitations and issues with solving the MILP formulation. For example, the provided MILP formulation has the objective of minimizing the cost of posting collateral. The objective function can be set to the sum of elementwise multiplications between Ω and Q:

$${min}_{Q} {\sum }_{i = 1}^{n} {\sum }_{j = 1}^{m} {Ω}_{ij} {Q}_{ij} . \qquad ( 8 )$$

From a practical perspective, formulated problems can be represented in the form of programmatic subroutines. As noted herein, a MILP formulated problem is represented as a MILP formulated subroutine, which is then transformed into a QUBO formulated subroutine for solving. The transformation is a computational approach that is used to allow for practical implementation when complexity and scaling have rendered the MILP problem very difficult or impossible to solve.

As an example, a problem instance can involve allocating a single asset i across two accounts, j and l, which have long- and short-term requirements, respectively. In this problem instance, the objective function can be formulated as:

$${min}_{Q} {ω}_{i} {Q}_{ij} + ( 1 - {ω}_{i} ) {Q}_{ij} . \qquad ( 9 )$$

For this problem instance, the coefficient preceding short-term allocations is set to 1−wᵢ so that allocations of higher quality assets for trades with a short duration are favored.

The ColOpt problem can then be expressed using an MILP formulation:

$${min}_{Q} {\sum }_{i = 1}^{n} {\sum }_{j = 1}^{m} {Ω}_{ij} {Q}_{ij} ∀ i ∈ ℐ , ∀ j ∈ 𝒜 \qquad ( 10 a )$$

$$s . t . {\sum }_{j = 1}^{m} {Q}_{ij} \leq 1 ∀ i ∈ ℐ \qquad ( 10 b )$$

$${Q}_{ij} {a}_{i} \leq {B}_{ij} ∀ i ∈ ℐ , ∀ j ∈ 𝒜 \qquad ( 10 c )$$

$${\sum }_{i = 1}^{n} {T}_{ig} {Q}_{ij} {a}_{i} \leq {K}_{gj} ∀ g ∈ 𝒢 , ∀ j ∈ 𝒜 \qquad ( 10 d )$$

$${\sum }_{i = 1}^{n} {Q}_{ij} {a}_{i} {v}_{i} {H}_{ij} \geq {c}_{j} ∀ j ∈ 𝒜 \qquad ( 10 e )$$

$${Q}_{ij} \geq 0 ∀ i ∈ ℐ , ∀ j ∈ 𝒜 , \qquad ( 10 f )$$

Equation 10b is the constraint that ensures no asset is distributed to the accounts beyond unity. Equation 10c amounts to the limit constraints for each asset-account pairing. Equation 10d is the constraint that limits the quantity of particular groups of assets to certain amounts. Equation 10e is the requirement constraint that enforces that a suitable value is allocated such that the lender's loan is secured.

Embodiments described herein map the MILP formulated problem onto a quadratic unconstrained binary optimization (QUBO) by replacing all continuous variables in the linear objective function with a plurality of discrete binaries and encoding the plurality of constraint equations.

If a variable is between [0,1], the system is configured to digitally partition an interval and approximate it, as the system cannot encode continuous values quantumly.

The QUBO model can be applied to a range of combinatorial optimization problems that are known to be NP-hard (e.g., maximum cut, minimum vertex cover, multiple knapsack, and graph coloring problems). The QUBO model can be applied to a diverse set of domains. For example, applications of the QUBO model can be used in the automotive industry, portfolio optimization, optimal logistical scheduling, electricity network line management, traffic flow optimization, job scheduling, railway conflict management, bioinformatics, etc.

The transformation provides a practical solution to address technical limitations that arise primarily in respect of MILP limitations at scale. Accordingly, using the QUBO, it becomes possible for practical solving at an acceptable level of accuracy loss.

NISQ devices can provide an advantage in the finance industry as these business use cases can be well-formulated for near-term quantum devices. Quantum finance comprises three main areas: stochastic modeling (e.g., quantum alternatives to Monte Carlo simulations), machine learning, and optimization. For example, in this context, a prototypical optimization use case is that of (Markowitz) portfolio optimization. Portfolio optimization shares a few similarities with ColOpt, but there are a few fundamental differences as well. A difference is that the objective function for ColOpt is inherently linear at first glance, but transformations can be performed to convert the ColOpt into a well-behaved formulation suitable for a variety of NISQ solvers (e.g., Ising NISQ) or hybrid solvers.

QUBO formulations have a one-to-one mapping to the Ising Hamiltonian model, making QUBOs a fundamental element of quantum-inspired computing. For example, the digital annealer developed by Fujitsu™ and the adiabatic quantum computers manufactured by D-wave systems employ the QUBO model to address complex optimization problems. QUBO formulated-optimization problems are suitable for various approaches and technologies, such as tensor networks and NISQ devices that use algorithms (e.g., QAOA). The QUBO model is an important tool for quantum optimization with potential applications across a range of quantum computing platforms and formulating constrained problems as such highly affects the quality of the solutions obtained.

Embodiments described herein can represent the QUBO formulation via a graph problem. Given an undirected graph G=(V, E) with a vertex set V={1, 2, . . . , N} connected by the edge set E={(i, j),}, i, j∈V, the cost function is defined as follows:

$$min {\sum }_{i = 1}^{N} {A}_{ii} {x}_{i} + {\sum }_{i = 1}^{N - 1} {\sum }_{j > i}^{N} {A}_{ij} {x}_{i} {x}_{j} \qquad ( 11 )$$

wherein x∈{0, 1} are the binary variables and the elements Aᵢⱼ∈ [symbol] ^{N×N} are the problem instance parameters.

At the most fundamental level, a QUBO can be expressed as follows:

$$min {x}^{T} Qx + b \qquad ( 12 )$$

wherein the decision matrix Q∈ [symbol] ^{N×N} contains the problem instance and b∈ [symbol] is a constant offset term.

By using a suitable change of variables

$${x}_{i} = \frac{1 - {σ}_{i}}{2} ,$$

Equation 11 can be mapped onto the Ising model Hamiltonian as follows:

$$H = - {\sum }_{j} {h}_{j} {σ}_{j} - {\sum }_{j < k} {J}_{jk} {σ}_{j} {σ}_{k} \qquad ( 13 )$$

wherein σ∈{−1, 1}^{N} are the (classical) spins, h∈ [symbol] ^{N} is the magnetic field, and J∈ [symbol] ^{N×N}, diag(J)=0, the spin-spin interaction symmetric matrix between adjacent spins j and k. The problem to be solved is:

$${min}_{{σ}_{i} ∈ \{ - 1 , 1 \}} H . \qquad ( 14 )$$

### Example Application: Knapsack Problem

As an example application, the QUBO formulation can be practically implemented to solve for small instances of the Knapsack Problem. The Knapsack Problem includes a given set of weights w∈ [symbol] _{≥0}ⁿ, and their corresponding values v∈ [symbol] _{≥0}ⁿ, and the objective is to maximize the total value of the items that can be packed into a knapsack subject to a given weight limit. The problem can be mathematically defined as follows:

$$max {\sum }_{i = 1}^{n} {v}_{i} {x}_{i} s . t . {\sum }_{i = 1}^{n} {w}_{i} {x}_{i} \leq W \qquad ( 15 )$$

wherein W is the maximum weight limit (threshold) of the knapsack and xᵢ is the binary variable representing whether the ith item is to be placed in the knapsack. The best running-time algorithm for solving the Knapsack Problem is based on dynamic programming with pseudo-polynomial complexity O(dₙW), wherein dₙ is the number of distinct weights available and the running-time of the algorithm is near-linear.

An example problem instance of the Knapsack problem can comprise ten items and possess a known optimal solution. Table 1 shows example input data pertaining to the items in this problem instance:

TABLE 1

| Object label | A | B | C | D | E | F | G | H | I | J |
|---|---|---|---|---|---|---|---|---|---|---|
| Weight | 23 | 31 | 29 | 44 | 53 | 38 | 63 | 85 | 89 | 82 |
| Value | 92 | 57 | 49 | 68 | 60 | 43 | 67 | 84 | 87 | 72 |

Total capacity of the knapsack is 165.

The Knapsack Problem is weakly NP-complete, but simple instances of the problem can be efficiently solved by a range of classical solvers as well. For example, the HIGHS and GLPK solvers can be used to solve the problem to yield the known optimal solution. For the QUBO formulation of the Knapsack Problem, other solvers, such as the open-source Julia libraries ToQUBO.jl, Qiskit's optimization module, the open-source Python library PyQubo (operating under SA), and the emulation of the proprietary Fujitsu digital annealer, can be used to solve the problem. The known optimal solution for this problem instance corresponds to an objective value of 309 and uses the full capacity of the knapsack.

In some embodiments, constraints of the optimization problem can be encoded to a QUBO model by using balanced formulations of the problem, including balanced slack variables for penalization. For example, slack-based approaches can include off-the-shelf LP-to-QUBO converters, such as Qiskit's QuadraticProgram To-Qubo class and methods and the Julia package To-QUBO.jl. A slack variable is an “assisting variable” induced artificially into the problem in order to aid computations.

In the process of converting MILPs to QUBOs, a slack variable S∈ [symbol] _{≥0}, can be introduced for each linear inequality for transformation into an equivalent linear equality. A penalty term can then be constructed based on the slack variable, and the term is squared as the standard approach. A variety of different slack-based QUBO formulations can be used for the Knapsack Problem. For example, a corresponding penalization term with weight λ₀∈ [symbol] ₊ can be given by the equality:

$${{λ}_{0} ( {\sum }_{i = 1}^{n} {w}_{i} {x}_{i} - W + S )}^{2} = 0. \qquad ( 16 )$$

The purpose of the auxiliary slack variable S is to reduce this term to 0 once the constraint has been satisfied, 0≤S≤maxₓ Σᵢⁿwᵢxᵢ−W. In practice, S can be decomposed into binary representation using variables sₖ∈{0,1}.

In an embodiment, the slack variable S can be formulated as a “log encoding” representation, as follows:

$$S = {\sum }_{k = 1}^{{N}_{s}} {2}^{k - 1} {s}_{k} . \qquad ( 17 )$$

wherein the parameter Ns corresponds to the number of binary variables required to represent the maximum value that can be assigned to the slack variable S. In the case of the Knapsack Problem, Nₛ=[log₂(W)], where [x] is the ceiling function.

The full QUBO formulation for the “log encoding” approach to the Knapsack Problem takes the form of maximizing the following augmented Lagrangian objective function:

$${\sum }_{i}^{n} {v}_{i} {x}_{i} - {{λ}_{0} ( {\sum }_{i}^{n} {w}_{i} {x}_{i} - W + {\sum }_{k = 1}^{N} {2}^{k - 1} {s}_{k} )}^{2} \qquad ( 18 )$$

For this problem instance, the number of slack bits required for implementation of this approach is Nₛ=[log₂ (165)]=8. Two different regimes for the weight of the penalty term λ₀ can be used: 1) wherein the penalty term and the cost function have equal weighting (λ₀=1); and 2) where the penalty term is more important than the cost function (λ₀=1×10⁴). As an example, D-wave's simulated annealer or the emulation of the digital annealer from Fujitsu™ can be employed as a heuristic optimizer in both scenarios to return the optimal solution, consistent with the results that can be obtained from classical solvers.

Optimization may occur in two forms. 1. Minimize and objective, subject to some constraints; and 2. Maximize a similar objective (maybe with a minus sign) subject to some related but different constraints.

Finally, these two approaches are called primal and dual. The approaches are utilized into a Lagrangian function and a mini-max game. Then, the problem becomes unconstrained and the constraints take the form of terms in the objective function multiplied by a penalty term. This way, the system create an optimization problem where the constraints are hidden in the objective and it sometimes can be mapped to a computer more easily (e.g., the QUBO computing approach proposed herein).

In another embodiment, the following “one-hot encoding” objective function that follows a similar Lagrangian paradigm can be maximized instead:

$${\sum }_{i}^{n} {v}_{i} {x}_{i} - {{λ}_{0} ( {\sum }_{i}^{n} {w}_{i} {x}_{i} - {\sum }_{k = 1}^{W} {ks}_{k} )}^{2} - {{λ}_{1} ( 1 - {\sum }_{k = 1}^{W} {s}_{k} )}^{2} \qquad ( 19 )$$

In this formulation, the number of slack bits is equal to the capacity of the knapsack W. An additional penalty term is required to enforce only one of these slack bits to be assigned a value of 1. A disadvantage of this formulation is that the binary input length for the slack variables scales linearly with the values of the constraints, leading to an unreasonably large number of bits for problem instances with large W that can exhaust available resources. Various weight regimes are possible for λ₀ and λ₁, in relation to the weight of the cost function term. For this problem instance, selecting λ₀=10⁻¹ and λ₁=10³ can enable identification of the optimal solution for both neal and Fujitsu cases.

In another embodiment, off-the-shelf approaches can be used to determine a solution for a balanced formulation of the Knapsack Problem QUBO.

For example, ToQUBO.jl, an open-source Julia package that automatically reformulates a variety of optimization problems, including MILPs, can be applied to a balanced formulation of QUBO. The user can use the JUMP package to build the MILP form of the Knapsack Problem. ToQUBO.jl also provides several ways for encoding variables into binary representations, including the aforementioned logarithmic and one-hot approaches. The user can provide a tolerance factor to manage the upper bound on the representation error caused by the binarization, which can be especially useful for continuous decision variables. ToQUBO.jl also works in conjunction with QUBODrives.jl, a companion package that can provide common API to use QUBO sampling and annealing machines (e.g., D-wave's simulated annealer) and quantum annealers (e.g., DWaveNeal.jl). ToQUBO.jl can be used to employ the aforementioned logarithmic and one-hot binary encodings to find the optimal solution to the Knapsack Problem.

As another example, Qiskit's optimization module includes functionality for automatically transforming quadratic programs into QUBOs (the binary property enables this functionality). The transformation can be initiated by initializing a QuadraticProgram and, subsequently, utilizing the QuadraticProgramToQubo class to convert it into a QUBO via the log-encoding method for slack variables. The module allows the formulated QUBO to be fed into several algorithms used by Qiskit to solve optimization problems (e.g., SampingVQE, QAOA). The user can extract the coefficient matrix to use with other solvers, such as neal and Fujitsu's digital annealer, to find the optimum solution, which can however require a larger number of runs to reach the solution compared with other methods. For larger problem instances, this method can become computationally expensive, and may thus be an inadequate choice for the ColOpt problem.

In other embodiments, constraints of the optimization problem can be encoded to a QUBO model by using unbalanced penalization. This approach is particularly useful for QAOA solutions as it reduces the resources required by a gate-based machine.

Given that the number of qubits required scales proportionally with the number of variables, a methodology can be employed that eliminates the need for slack variables. An approximation technique can be adopted that creates penalty terms that take on small values when the constraint is fulfilled and large values when it is violated. The inequality can be rearranged to define an auxiliary function:

$$h ( x ) = {\sum }_{i}^{n} {w}_{i} {x}_{i} - W \leq 0. \qquad ( 20 )$$

Using the exponential function ƒ(x):=e^{h(x)}, the constraint on h(x) is satisfied. However, since only linear and quadratic terms may be encoded into a QUBO, it is necessary to use a second-order Taylor approximation of ƒ(x). For weights λ₀ and λ₁, the resulting QUBO for the Knapsack Problem reads:

$${\sum }_{i}^{n} {v}_{i} {x}_{i} + {λ}_{0} ( {\sum }_{i}^{n} {w}_{i} {x}_{i} - W ) + {{λ}_{1} ( {\sum }_{i}^{n} {w}_{i} {x}_{i} - W )}^{2} = 0. \qquad ( 21 )$$

The optimal solution can be reached for this Knapsack Problem instance by using the PyQUBO or Fujitsu™ unbalanced approaches, signifying that the unbalanced formulation exhibits some robustness. This formulation can produce close to optimal results for larger Knapsack Problem instances as well, but can periodically softly break the maximum weight limit. Breaking the maximum weight limit means going beyond the allowed total sum of weights.

An advantage of reformulating the optimization problem as an unbalanced QUBO instead of the traditional balanced approaches is that one significantly reduces the number of variables, and hence, the number of bits required to represent the problem, which effectively reduces the resource cost, as well as the search space of the optimal solution.

However, drawbacks associated with this unbalanced approach are that, because of the use of a heuristic penalization function, the constraints are less strict and the ground state of the corresponding Ising Hamiltonian is less likely to coincide with the optimal solution of the problem.

The QUBO formulation can also be applied to different instances of problems, such as the traveling salesperson problem, bin packing problem, and Knapsack problem, resulting in finding that the minimum energy eigenvalue of the corresponding Hamiltonian does not necessarily coincide with the optimal solution, which is usually found to be amongst the lowest energy eigenvalues, enhancing applicability of this approach to large-scale problems.

Table 2 displays a list of MILP and QUBO solvers, using the slack-based and unbalanced approaches, that can be used to find the optimal solution for the provided instance of the Knapsack Problem:

| Problem Encoding | Solver |
|---|---|
| ILP | GLPK |
| | HiGHS |
| ToQUBO.jl | D-wave |
| QuadraticProgramToQUBO | D-wave (PyQubo) |
| | Fujitsu |
| Log | D-wave (PyQubo) |
| | Fujitsu |
| One-hot | D-wave (PyQubo) |
| | Fujitsu |
| Unbalanced | D-wave (PyQubo) |
| | Fujitsu |

### ColOpt QUBO Formulation

Embodiments described herein map the MILP formulated problem onto a quadratic unconstrained binary optimization (QUBO) by replacing all continuous variables in the linear objective function with a plurality of discrete binaries and encoding the plurality of constraint equations.

To formulate the QUBO, a change of variables must be made so that the decision variable is represented by binaries, which imposes certain limitations on the allocations of assets. To enable binary encoding of the decision variable Q, it can be represented as a matrix q containing binary elements. This transformation enables allocation of the assets in a limited number of ways:

$$q = ( \begin{matrix}{q}_{11} & … & {q}_{01} \\ ⋮ & ⋱ & ⋮ \\ {q}_{n 1} & … & {q}_{n m}\end{matrix} ) . \qquad ( 22 )$$

In Equation 22, qᵢⱼ is a n-bit binary variable expressing the fractional allocation of asset i to account j:

$${q}_{ij} = {x}_{ij}^{b = 1} , … , {x}_{ij}^{b = B} , {x}_{ij}^{b} ∈ \{ 0 , 1 \} \qquad ( 23 )$$

wherein B is the number of bits chosen. For example, if B=4, the largest number that can be represented by four bits is 1111_{bin}=15_{dec}. Thus, the allocation can be split into 15 fractions, wherein if qᵢⱼ=0100_{bin}=4_{dec}, then 4/15 of asset i is allocated to account j. By increasing B, the precision of the allocations increases.

The fractional allocation can be discretized by discretizing the interval [Qᵢⱼ^{min},Qᵢⱼ^{max}]:

$${Q}_{ij}^{max} - {Q}_{ij}^{min} = {\sum }_{b = 1}^{B} {p}_{ijb} = {\sum }_{b = 1}^{B} \frac{{2}^{( b - 1 )} ( {Q}_{ij}^{max} - {Q}_{ij}^{min} )}{M} . \qquad ( 24 )$$

wherein M is the maximum value that can be represented by a binary string of length B(M=2^{B}−1). In an example problem instance, Qᵢⱼ^{min}=0 and Qᵢⱼ^{max}=1 such that Qᵢⱼ^{max}−Qᵢⱼ^{max}=1.

The discretized amount of item i that is allocated to account j is then described by the dot product of the binary vector x_{ijb}=(xᵢⱼ₁, . . . , x_{ijB})^{T} and p_{ijb}=(pᵢⱼ₁, . . . , p_{ijB})^{T}:

$${q}_{ij} = {\sum }_{b = 1}^{B} {p}_{ijb} {x}_{ijb} ≡ {p}_{ijb} {x}_{ij}^{b} \qquad ( 25 )$$

wherein the Einstein summation convention (upper-lower repeated indices contract) can be used for brevity. By pairing each bit in the bit string of qᵢⱼ with a coefficient p_{ijb}, more values can be represented in the allowed range, improving accuracy.

The cost function is then written as:

$${\sum }_{i = 1}^{n} {\sum }_{j = 1}^{m} {Ω}_{ij} {p}_{ijb} {x}_{ij}^{b} . \qquad ( 26 )$$

The same replacement Qᵢⱼ→p_{ijb}xᵢⱼ^{b} can be made in the remaining constraints of the problem to construct the binarized collateral optimization problem. Classical solvers (open source and commercial) are available that can find the global minimum of the problem in this form.

The total number of variables used to construct this binarized version of the problem is O(nmB). Since the continuous variables have been replaced with discrete binaries, the accuracy of the solution is expected to be reduced. This can be mitigated by increasing B, but a compromise is required between accuracy and resource usage. The granularity for the fractional allocation is 1/M.

Embodiments described herein introduce a QUBO formulation for the collateral optimization ColOpt problem, incorporating slack variables. The constraints outlined in Equations 10b-10e significantly influence the number of bits necessary to encode the slack variables, potentially leading to an extensive bit requirement, which can be addressed by employing the log-encoding method. More bits mean more precision, but this also increases complexity so a practical computing approach is also proposed herein to constrain approach complexity.

For constraints expressed as “less-than-or-equal-to” inequalities, the number of bits required to encode the slack variable can be readily computed using [log 2], where u represents the upper bound of the constraint. As the objective is to minimize the excess value of the collateral posted, employing slack variables might prove inadequate since their purpose is to diminish the corresponding penalty term to 0 for any values satisfying this constraint. In contrast, within MILP frameworks, the solution to a minimization problem typically aligns closely with the lower bound of such a constraint. Thus, the exposure requirement can be altered by transforming Equation 10e into an equality constraint, thereby relaxing the original formulation and as a result, the associated penalty term requires no slack variables:

$${\sum }_{i = 1}^{n} {Q}_{ij} {a}_{i} {v}_{i} {H}_{ij} = {c}_{j} , ∀ j ∈ 𝒜 \qquad ( 27 )$$

With the objective of minimizing the associated penalty terms originating from Equation 27 the QUBO should yield a solution conforming to the boundaries of the exposure constraints.

A disadvantage of this strategy is the intrinsic stochastic characteristic of annealing techniques and their propensity to become ensnared in local minima, potentially resulting in marginally exceeding or not quite meeting the mandatory exposure. Furthermore, because the upper bound for each consistency constraint is equal to one, the consistency constraint form must be adjusted so that the number of required slack bits can be calculated. The binarized version of the constraint can be rearranged to attain a fractional form:

$${\sum }_{j = 1}^{m} {p}_{ijb} {λ}_{ij}^{b} = {\sum }_{j = 1}^{m} {\sum }_{b = 1}^{B} \frac{{2}^{b - 1} {x}_{ij}^{b}}{M} \leq 1 ∀ i ∈ ℐ \qquad ( 28 )$$

By multiplying both sides by M, it can be determined that the highest value that can be represented by the bitstring can be used as the new upper bound, allowing for determination of the required number of slack bits. A bitstring can be used to represent any numeric value in decimal or bits. Bits are described herein due to encoding requirements. The penalty term for each of the n consistency constraints can be written as:

$${\sum }_{i = 1}^{n} {( {\sum }_{j = 1}^{m} M ( {p}_{ijb} {x}_{ij}^{b} - 1 ) + {S}_{con} )}^{2} \qquad ( 29 )$$

wherein S_{con} is the slack variable for each constraint, which can be encoded by binary variables sₖ via

$${S}_{con} = {\sum }_{k = 1}^{⌈ {log}_{2} ( M ) ⌉} {2}^{k - 1} {s}_{k} . \qquad ( 30 )$$

Instead of introducing a penalty term for one-to-one constraints in Equation 10c, these constraints can be satisfied by reducing the number of bits representing each allocation so that the limits cannot be violated. The number of bits representing an allocation nᵢⱼ can be determined by

$${n}_{ij} = ⌊ {log}_{2} ( \frac{{B}_{ij}}{{a}_{ij}} M ) ⌋ . \qquad ( 31 )$$

The upper limit B of the summation in Equation 25 is accordingly replaced with nᵢⱼ, as this is the number of bits representing the allocation qᵢⱼ. The result from the logarithmic function can be floored as the alternative would still allow violations. A consequence of this however, is that the one-to-one constraints in the QUBO are more restrictive than their MILP counterpart.

For the many-to-one constraints in Equation 10d, log-encoded slack variables S_{K}_{ᵢⱼ} can be introduced.

The full QUBO objective function can be derived as follows:

$${λ}_{0} {\sum }_{i = 1}^{n} {\sum }_{j = 1}^{m} {Ω}_{ij} {p}_{ijb} {x}_{ij}^{b} + {λ}_{1} {\sum }_{i = 1}^{n} {( {\sum }_{j = 1}^{m} M ( {p}_{ijb} {x}_{ij}^{b} - 1 ) + {S}_{con} )}^{2} + {λ}_{2} {\sum }_{j = 1}^{m} {( {\sum }_{i = 1}^{n} {p}_{ijb} {x}_{ij}^{b} {a}_{i} {v}_{i} {H}_{ij} - {c}_{j} )}^{2} + {λ}_{3} {\sum }_{j = 1}^{m} {\sum }_{g = 1}^{G} {( {\sum }_{i = 1}^{n} {p}_{ijb} {x}_{ij}^{b} {T}_{ig} {a}_{i} - {K}_{gj} + {S}_{{K}_{ij}} )}^{2} . \qquad ( 32 )$$

Embodiments described herein introduce an unbalanced QUBO formulation for the collateral optimization ColOpt problem. The constraints set out in Equations 10b-10f can be converted into penalty terms for the QUBO through unbalanced penalization. Auxiliary functions can be defined from the constraints and Taylor approximations of appropriate exponentiations of these functions can be used to derive the penalty terms.

For example, for the consistency constraint in Equation 10b, the upper bound can be moved to the left-hand side of the inequality and set an auxiliary function h(x):

$$h ( x ) = {\sum }_{j = 1}^{m} {p}_{ijb} {x}_{ij}^{b} - 1 \leq 0. \qquad ( 33 )$$

Since Equation 33 is a “less equal to zero” inequality, e^{h(x)} can be used to derive a penalty term that takes small values when the constraint is satisfied and large values when violated. QUBOs may only contain linear and quadratic terms, so a second-order Taylor approximation must be taken to obtain:

$${λ}_{1} ( {\sum }_{j = 1}^{m} {p}_{ijb} {x}_{ij}^{b} - 1 ) + {{λ}_{2} ( {\sum }_{j = 1}^{m} {p}_{ijb} {x}_{ij}^{b} - 1 )}^{2} \qquad ( 34 )$$

for all i∈I. Essentially, the first term of Equation 34 favors solutions that satisfy the constraint while being as far away from the upper bound as possible. The second term, instead, favors solutions that are as close to the upper bound as possible. Effective tuning of the parameters is, therefore, necessary to balance the effects of each term.

As the approach is operated, hyperparameter values may be “discovered” and worked out, similar to values such as “temperature” in LLMs (i.e., how entropic the model needs be). These can be used for controlling, for example, how much to penalize, what annealing schedule, etc.

Equation 34 is valid only for one asset and can therefore be modified to encompass all assets:

$${λ}_{1} {\sum }_{i = 1}^{n} ( {\sum }_{j = 1}^{m} {p}_{ijb} {x}_{ij}^{b} - 1 ) + {λ}_{2} {\sum }_{i = 1}^{n} {( {\sum }_{j = 1}^{m} {p}_{ijb} {x}_{ij}^{b} - 1 )}^{2} \qquad ( 35 )$$

The remaining constraints can be promoted to penalty terms in the QUBO. The final QUBO can be written as:

$${λ}_{0} {\sum }_{i = 1}^{n} {\sum }_{j = 1}^{m} {Ω}_{ij} {p}_{ijb} {x}_{ij}^{b} + {λ}_{1} {\sum }_{i = 1}^{n} ( {\sum }_{j = 1}^{m} {p}_{ijb} {x}_{ij}^{b} - 1 ) + {λ}_{2} {\sum }_{i = 1}^{n} {( {\sum }_{j = 1}^{m} {p}_{ijb} {x}_{ij}^{b} - 1 )}^{2} - {λ}_{3} {\sum }_{j = 1}^{m} ( {\sum }_{i = 1}^{n} {p}_{ijb} {x}_{ij}^{b} {a}_{i} {v}_{i} {H}_{ij} - {c}_{j} ) + {λ}_{4} {\sum }_{j = 1}^{m} {( {\sum }_{i = 1}^{n} {p}_{ijb} {x}_{ij}^{b} {a}_{i} {v}_{i} {H}_{ij} - {c}_{j} )}^{2} + {λ}_{5} {\sum }_{j = 1}^{m} {\sum }_{g = 1}^{G} ( {\sum }_{i = 1}^{n} {p}_{ijb} {x}_{ij}^{b} {T}_{ig} {a}_{i} - {K}_{gj} ) + {λ}_{6} {\sum }_{j = 1}^{m} {\sum }_{g = 1}^{G} {( {\sum }_{i = 1}^{n} {p}_{ijb} {x}_{ij}^{b} {T}_{ig} {a}_{i} - {K}_{gj} )}^{2} \qquad ( 36 )$$

Embodiments described herein compute an optimal allocation of the set of assets to the set of parties or accounts by computing a global optimum result of the QUBO using a solver.

As an example, a small instance of the ColOpt problem can be defined on a synthetic realistic small dataset, and SA can be used as a solver. SA, as a metaheuristic algorithm, can be sensitive to the problem structure and its performance can vary significantly depending on the problem instance. The increased complexity of the ColOpt problem may create more difficulty for the SA to explore the solution space effectively, leading to suboptimal results or longer convergence times. In such cases, it may be beneficial to fine-tune the parameters of SA to improve its performance on more complicated problem instances.

In the small instance of the ColOpt problem, there can be a portfolio of ten assets that have an approximate combined value of $8.86 M with assets that can be categorized by their tier rating, w={0.2,0.5,0.8}, into low-, mid-, and high-tiered assets, respectively. Furthermore, the number of assets belonging to each category can be chosen to be 4, 2, and 4, respectively. The assets are to be distributed in order to meet the requirements of five accounts. These requirements are distinguished by their duration, two of which are long term and have a combined exposure of ˜$1.49 M. The remaining are short-term requirements with a total exposure of ˜$1.09 M.

Due to restrictions, the problem can be slightly relaxed by removing many-to-one constraints from Equation 10d. In the absence of these constraints, this ColOpt problem instance has a global optimum that can be obtained using classical strategies.

To balance the trade-off between the precision of results and the runtime performance, along with the limitation of the total number of bits that can be implemented in the solvers, the length of the bitstring representing each allocation can be set to be 7. Then, the granularity of the allocations is 1/127˜ 0.0079% (since M=127). In other words, the lowest percentage of available asset quantity that may be posted to any one account is approximately 0.0079%. This is important if an asset quantity is significantly large, as the corresponding solution can allocate more than what is necessary to meet the requirements. If strict limits are considered, many violations can occur if the bitstring length chosen is inadequate. The sample must contain sensible values for the quantity of each asset so that they can be distributed with enough precision to satisfy the exposure requirements efficiently. If no inequality constrains are included in the instance, then a total of 350 qubits are required for both formulations (10 assets, 5 accounts, 7). Depending on the way the constraints are introduced, the number of qubits can be reduced to 228 qubits (in the case of the unbalanced formulation) and 298 qubits (for the balanced form), as the consistency constraint in this instance still requires slack variables.

Solving QUBO equations to obtain results that accurately reflect the goal of the objective function while simultaneously satisfying all constraints relies on the fine-tuning of the Lagrange multipliers. The consistency constraint in Equation 10b is a hard constraint, as a solution that violates this constraint would not translate into a sensible business solution. Conversely, the exposure requirement in Equation 10e is a soft constraint and can allow for small violations to some margin E. For both balanced and unbalanced formulations, there are significant differences between the magnitudes of the coefficients of each term in the QUBO, which can make fine-tuning of the penalty weights difficult. To manage this, each term in the QUBOS can be normalized by dividing by their largest coefficient and then scaling such that the lowest coefficient in each term has an order of magnitude of 1. The weight for the cost function can be chosen to be a magnitude larger than those of the constraints so that high-quality solutions can be achieved. The weight of the exposure and consistency terms can then be retrospectively increased to ensure that the system's constraints are satisfied.

A disadvantage of this approach is that performing only a limited number of runs may not allow the annealing process to explore sufficient search space, which can result in the results not reaching the global optimum solution nor producing the globally optimal allocation with each run converging in a different local optimum. Increasing the number of runs (e.g., decreasing the step size) and utilizing more computational powers can remedy this limitation, but this is difficult due to limited resources and necessary compromising between computational runtime and solution accuracy.

In some embodiments, hybrid solvers (e.g., D-wave's constrained quadratic model) can be used to solve the QUBO problem instead of relying on fine-tuning of the Lagrange multipliers.

Embodiments described herein can extrapolate, from the decision variable matrix of the optimal allocation of the set of assets to the set of parties, allocation parameters to realize the optimal allocation of the set of assets to the set of parties, the allocation parameters being a vector or list of parameter values.

Embodiments described herein can output or store the extracted allocation parameters.

Table 3 displays the values chosen for each of the penalty weights to tune the Lagrangian multipliers and the resultant objective value that is outputted for the ColOpt problem instance:

TABLE 3

| | | Cost | | | | | |
|---|---|---|---|---|---|---|---|
| | | Function | Consistency | | Exposure | | Objective |
| Formulation | Solver | λ₀ | λ₀ | λ₀ | λ₀ | λ₀ | Value |
| Balanced | D-wave's SA sampler | 10³ | 1 | — | 1 | — | 0.5898 |
| Balanced | Fujitsu's digital annealer | 10⁵ | 1 | — | 300 | — | 0.7559 |
| Unbalanced | D-wave's SA sampler | 1.5 × 10⁴ | 1 | 1 | 1 | 50 | 0.5244 |
| Unbalanced | Fujitsu's digital annealer | 2 × 10⁴ | 1 | 1 | 1 | 50 | 0.5803 |
| Continuous LP | HIGHS (Simplex) | — | — | — | — | — | 0.4746 |

Objective value obtained for running this solution is also documented and, for comparison, the value obtained by a continuous solver is displayed.

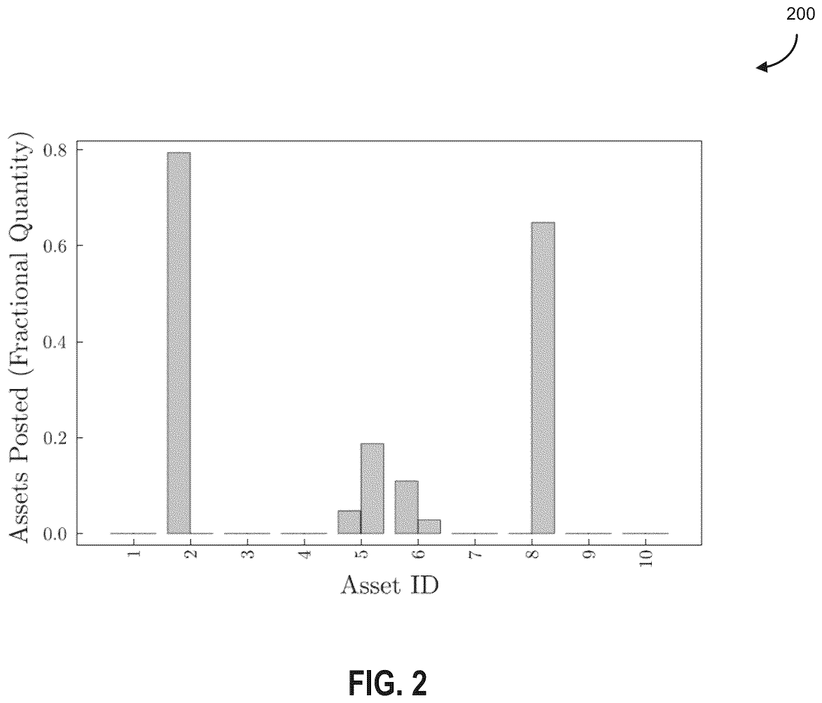

FIG. 2 is a bar graph 200 displaying an example of optimal allocations of assets among accounts, according to some embodiments. FIG. 2 displays the global optimal solution solved using HIGHS, with short-term requirements shown on the right and long-term requirements shown in left. Assets IDs of 1-4 are low-tier, 5-6 are mid-tier and the final 7-10 are high-tier assets.

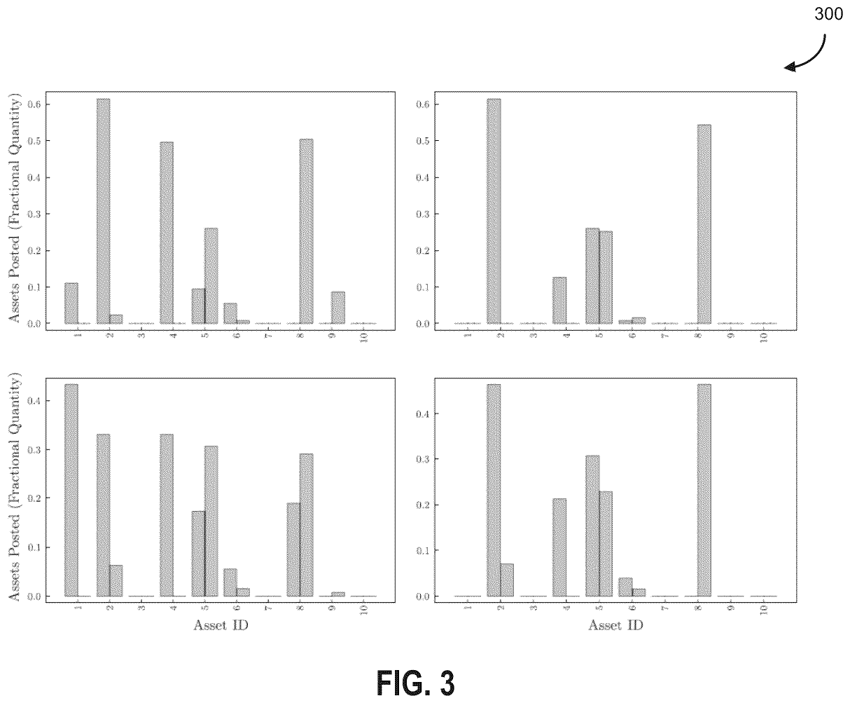

FIG. 3 is an example graphical representation 300 displaying optimal allocations of different assets among accounts with results determined using different solvers, according to some embodiments. FIG. 3 displays the allocation of different assets according to results determined using neal and Fujitsu™'s digital annealer with balanced and unbalanced formulations. Assets IDs of 1-4 are low-tier, 5-6 are mid-tier and the final 7-10 are high-tier assets.

Alternative approaches to the aforementioned slack-based and unbalanced approaches, can be used to solve problems with the QUBO formulation.

In an embodiment, the quantum hybrid Frank-Wolfe method can be used to solve the QUBO problem instances. The quantum hybrid Frank-Wolfe (Q-FW) method is an augmented Lagrangian method that is suitable to solve large QUBO instances due to a tight copositive relaxation of the original QUBO formulation while dealing with expensive hyperparameter tuning found in other QUBO heuristics. The Q-FW method first formulates constrained QUBOs as copositive programs, then employs the Frank-Wolfe method while satisfying linear (in) equality constraints. This is then converted to a set of unconstrained QUBOs suitable to be run on, e.g., quantum annealers. Q-FW can successfully satisfy linear equality and inequality constraints, in the context of QUBOs in computer vision applications, and can solve intermediary QUBO problems on actual quantum devices, demonstrating that Q-FW offers a valid alternative method to traditional quantum QUBO solvers.

An advantage of the Q-FW approach is its ability to address the costly hyperparameter tuning associated with other QUBO heuristics. By formulating constrained QUBOs as copositive programs, the Q-FW method can adeptly handle linear equality and inequality constraints and transform them into unconstrained QUBOs compatible with quantum annealers or other Ising machines. However, the general applicability and comparative efficiency of Q-FW methods against established quantum QUBO solvers is unclear.

In another embodiment, the Grover Adapted Binary Optimization (GABO) method comprises a fault-tolerant architecture that can achieve quadratic speed-up for combinatorial optimization problems in comparison to brute force search. To achieve this, efficient oracles must be developed to represent problems and identify states that satisfy specific search criteria. Quantum arithmetic can be utilized to develop the efficient oracles, but it can be expensive in terms of required Toffoli gates and ancilla qubits.

GABO can possibly offer a significant quantum advantage, a Grover-like quadratic speed-up for combinatorial optimization problems compared with the traditional brute force search. However, this speed-up can be only impactful for fault-tolerant quantum architectures, and may not be applicable to NISQ devices.

In another embodiment, physics-inspired Graph Neural Networks (GNNs) can be used to solve the QUBO problem instances. For example, a physics-informed GNN-based scalable general-purpose QUBO solver can be suitable for encoding any k-local Ising model (e.g., k=2 ColOpt problem). The GNN solver first drops the integrality constraints of the problem in order to obtain a differentiable relaxation ƒ′ of the original objective function ƒ and, subsequently, proceeds to unsupervised learning on the node representations. The GNN can then be trained to generate “soft assignments”, predicting the likelihood of each vertex in the graph belonging to one of the two distinct classes in conjunction with heuristics that aid in the consistency of the problem.

An advantage of using GNN-based methods is that the parallel processing capabilities of modern GPUs are well suited for GNN operations, making it feasible for these methods to handle large-scale graphs and complex optimization problems. Another advantage is the adaptability of GNNs, combined with unsupervised learning, that allows for general-purpose solutions that can be applied across a variety of problem instances without the need for extensive retraining. This universality potentially saves computational resources.

A disadvantage of GNN-based methods is that possible relaxations of integrality constraints for differentiability can lead to solutions that are not directly applicable or optimal for the original discrete problem. Furthermore, while GNNs can predict soft assignments efficiently, converting those interim assignments into definitive solutions might lead to suboptimal results.

In another embodiment, QUBO continuous relaxations with light sources is a heuristic quantum-inspired approach that can solve QUBO problem instances. The binary variables of the QUBO problem can be represented by the relative phases of laser sources, transforming the discrete optimization problem into a continuous one. The lasers interact through a unique optical coupler, which can use programmable diffractive elements and additional optical components to control the interaction between all pairs of lasers, with a dynamic range of up to 8 bits. This design enables a fully connected network between all lasers, facilitating high-resolution pairwise interactions that are crucial in solving QUBO problems. This method can achieve significantly better time to solution (TTS) results as the problem instance size increases.

An advantage of this method is its transformation of discrete variables into continuous variables that may offer alternate methods for efficient problem solving. The fully connected network ensures precise pairwise interactions, a fundamental requirement for many combinatorial problems, which not all Ising machines can achieve. Furthermore, this method can be employed using both emulation architecture and physical machines to achieve good performance. Another benefit of this method is that the required technology is readily available.

However, the general applicability and competitiveness of this method against established solvers remain unclear. Furthermore, the method's versatility and performance of this method on problems lacking known polynomial-time solutions is unknown.

In another embodiment, the technique of simulated quantum annealing (SQA) can be used to solve for QUBO problem instances. For example, Markov chains underlying SQA can effectively sample the target distribution and discover the global minimum of a spike cost function in poly time. Several techniques can be utilized, such as initiating warm starts (a technique applied to deep learning and QAOA) from the adiabatic path and using the quantum ground state probability distribution to comprehend the stationary distribution of SQA.

SQA methods can be effective for optimization problems with spike (deep and narrow) global optima. Thus, exploiting hybrid solvers that combine SQA and classical algorithms could offer alternative approaches to solving QUBO problem instances due to SQA's effectiveness in sampling target distributions.

In some embodiments, warm starting techniques can be performed to obtain improved solutions to the QUBO problem. Warm-starting techniques can be used in a hybrid classical-quantum or quantum-inspired solving approach. This approach benefits from the strengths of both classical and quantum optimization methods. Classical MILP Solvers (e.g., CPLEX, Gurobi, CVXPY of MOSEK) are highly optimized and can often find good solutions to large-scale problems in a reasonable amount of time. However, classical MILP solvers struggle to improve upon these solutions due to complexity of the problem space and/or budget/time constraints imposed by the user. Quantum and quantum-inspired solvers (e.g., QAOA, quantum annealing, and digital annealing), on the other hand, are well-suited for exploring complex solution spaces and can potentially find better solutions than classical methods, and if given a good initial starting point to converge efficiently, they might significantly improve upon the solutions. Due to the random nature of quantum solvers, time costs can be lowered by starting with traditional classical solvers and methods and gradually adapting to these new quantum approaches.

According to an aspect, embodiments described herein use a classical MILP solver to find a high-quality initial solution before converting to QUBO to use that initial solution as a starting point for a quantum or quantum-inspired solver to further optimize the solution.

The approach starts with a classical MILP solving the optimization problem by formulating the problem as an MILP and solving it using a classical solver (e.g., CPLEX, Gurobi) within a set time limit so that the solver returns the best solution found within a reasonable amount of time, even if not fully converged. The returned solution can be analyzed by the classical solver to identify any key features or patterns, such as which variables are set to their upper/lower bounds, which constraints are active/inactive, and structural properties of the solution. The approach can proceed with the current solution if the key features are assessed to be reasonable and feasible (e.g. does not violate constraints).

In some embodiments, based on the analysis of the classical solution, the values of certain variables that are likely to be part of the optimal solution can be fixed. This reduces the problem size and makes it more tractable for the quantum or quantum-inspired solver. For example, discovered bounds from the classical solver can be used as “updated” versions of the constraints found previously.

In some embodiments, a penalization term can be added into the objective function since a reasonable value for it has already been obtained from the classical solver so the QUBO can be penalized if it goes higher for a minimization problem or lower for a maximization problem.

Then, the reduced problem can be formulated as a QUBO, using the techniques mentioned herein and additional enhancements (e.g., dynamic constraint encoding) and initializing the QUBO with the variable values from the classical solution, such that the quantum or quantum-inspired solver starts from a good initial point.

The QUBO can then be solved using a quantum or quantum-inspired solver (e.g., quantum annealing, digital annealing, QAOA, digitized counterdiabatic optimization, etc). If the quantum or quantum-inspired solver finds a better solution than the classical solver, the improved solution can be inputted back into the classical solver as a starting point for further refinement. This iterative process of classical-quantum solving can be repeated until a satisfactory solution is found or a computation budget is exhausted (e.g., the solution can even be fed back into the classical solver now with much tighter bounds to begin the process again).

In some embodiments, optimization of the annealing schedule can be performed to obtain improved solutions to the QUBO problem. The optimization includes finding the best possible annealing schedule. This is one example of a hyperparameter essentially that needs be discovered.

In some embodiments, QUBO parameter optimization can be performed to obtain improved solutions to the QUBO problem. These can be discovered empirically.

In some embodiments, utilizing GPU and tensor cores can result in obtaining improved solutions to the QUBO problem as they are optimized for mixed-precision training in a machine learning model. Mixed-precision training allows for the GPU to combine the use of different numerical formats in one computational workload. For example, the GPU can use 32-bit floating point or numerical formats with lower precision such as 16-bit floating point. There are several benefits to using numerical formats with lower precision. The GPU would require less memory, enabling training and deployment of larger neural networks. Another benefit is that the GPU would require less memory bandwidth when using lower precision numerical formats which speeds up data transfer operations. Another benefit is that mathematical operations would run faster in reduced precision numerical formats.

Mixed-precision training offers computation speedup by performing operations in lower-precision numerical formats, while storing minimal information in higher-precision numerical formats to retain as much information as possible in critical parts of the machine learning model network to ensure no task-specific accuracy is lost compared to full precision training. For example, the GPU can identify steps that require full precision and use 32-bit floating point numerical format for only those steps while using 16-bit floating point numerical format everywhere else. Mixed-precision training can take matrices of lower-precision (e.g., 16-bit floating point) as input, but the finalized output can be 32-bit floating point with only a minimal loss of precision in the output. This can rapidly accelerate the calculations with a minimal negative impact on the ultimate efficacy of the model.

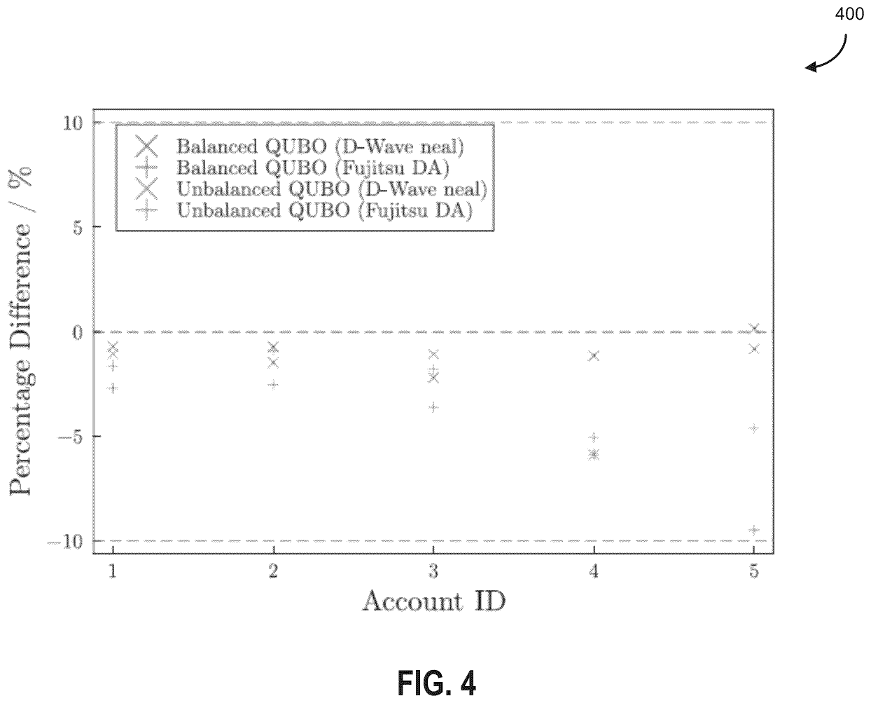

FIG. 4 is a scatterplot graph 400 displaying example percentage differences, for different solvers, between the total values posted and the required exposures for all the accounts, according to some embodiments. FIG. 4 displays the percentage of the exposure requirements that have been met for each account. The dashed line represents the solution given by the HIGHS solver that perfectly meets each requirement. There are greater deviations for the requirement of account 4, which is due to its outstanding exposure being an order of magnitude less than those of the other accounts, giving it a lower weighting in the QUBO.

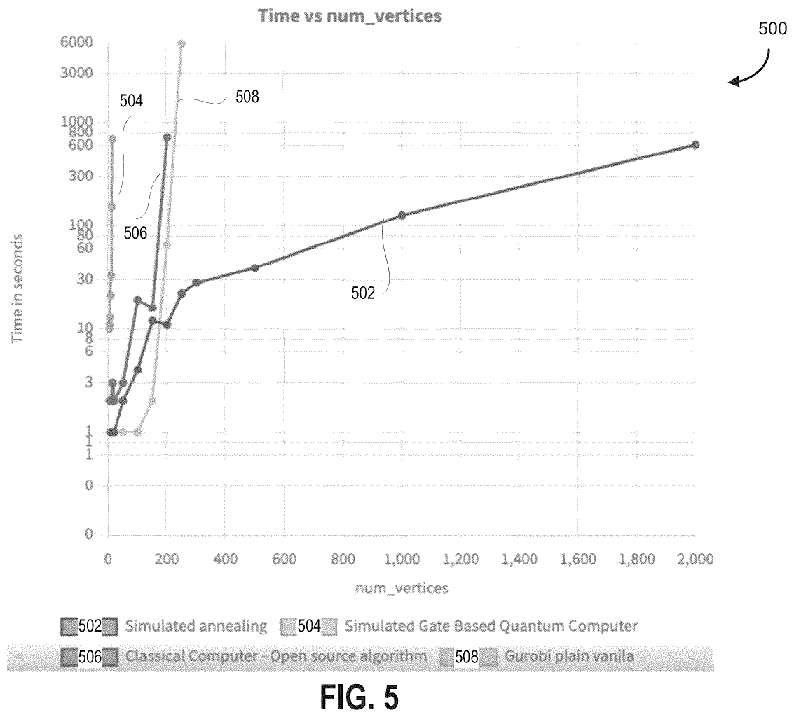

FIG. 5 is a graph 500 displaying performance complexities for different algorithms when being used to solve an example combinatorics optimization problem, according to some embodiments. 502, 504, 506, 508 all show different approaches, mapping time required in seconds against a number of vertices.

As shown in 500, the time required quickly scales up and approaches become practically infeasible as the complexity scales up as measured by the number of vertices (e.g., problem instance size). The use of the transformations described herein provide a practically useful approach for converting difficult computational problems into less difficult computational problems, albeit at a potential loss of accuracy. However, this loss of accuracy may be acceptable in situations where even a less than globally optimal, optimized solution is still useful.

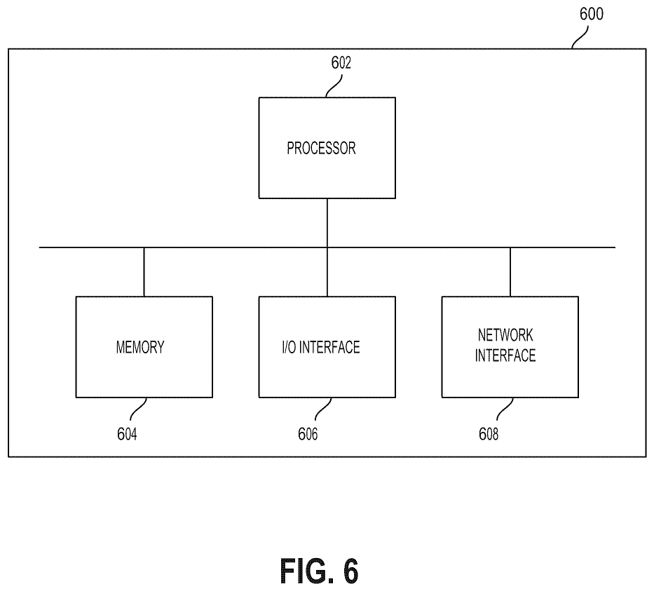

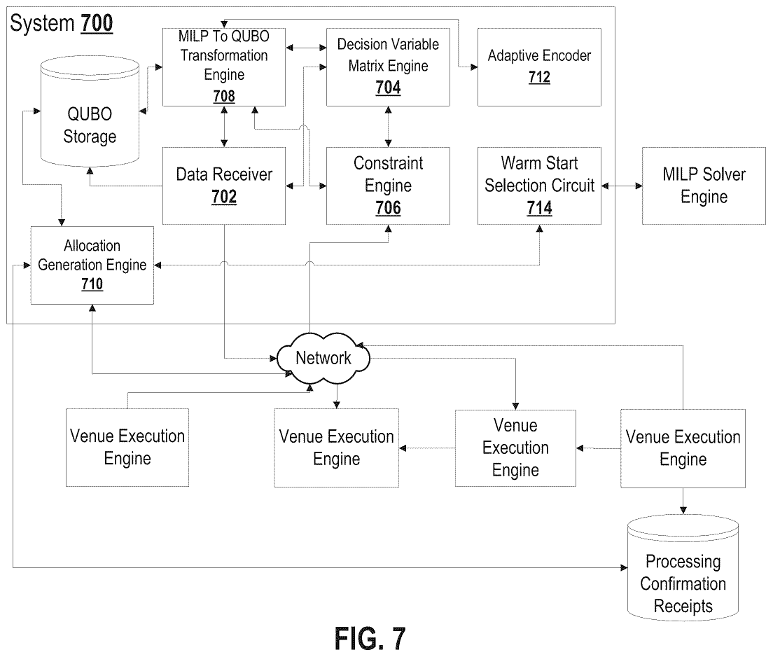

FIG. 6 is an example computing system diagram showing an example practical computing system for implementing the system for optimizing allocation of assets, according to some embodiments.

The computing device 600 can be a computer server or other physical computing hardware device that can be used to run Eigen models, and may reside, for example, in a data center. The computing device 600 includes one or more computer processors (e.g., microprocessors) 602 which are adapted to execute machine interpretable instructions, and interoperates with computer memory 604 (e.g., read only memory, random access memory, integrated memory). An input/output interface 606 can be provided that receives data sets representing inputs from devices such as computer mice, keyboards, touch screens, among others, and provides outputs in the form of interface element control for rendering on computer displays, such as monitors. A network interface 608 is provided that is adapted for electronic communications with other computing devices, such as downstream computing systems, data storage elements, data backup servers, among others. The network interface 608 can include various types of interfaces, including wireless connection interfaces, wired connection interfaces, connections with messaging buses, among others.

The processor 602 initializes a decision variable matrix data structure containing a plurality of object-party allocation variable as elements, wherein each object-party allocation variable is a continuous variable representing an allocation score of the corresponding data object that is allocated to the corresponding party, wherein the decision variable matrix has a column for each data object, wherein the decision variable matrix has a row for each party. The decision variable matrix can be practically implemented as a data structure storing a two-dimensional array. Each element in the decision variable matrix data structure can be set to have the value of an allocation score of the corresponding data object that is allocated to the corresponding party. The allocation score is a fractional value between 0-1 representing the proportion of the data object that is allocated to the party. For example, an element of 0.7 in the decision variable matrix data structure at the index [1, 2] position indicates that 0.7 or 70% of the data object represented by the first column of the array is allocated to the party represented by the second row of the array. The computer memory 604 stores the decision variable matrix data structure.

The processor 602 constructs a coefficients matrix data structure to store a plurality of tiers, wherein the coefficients matrix data structure has a column for each data object, wherein the coefficients matrix data structure has a row for each party, wherein each tier is a scalar value indicative of quality of the corresponding object-party allocation variable. The computer memory 604 stores the coefficients matrix data structure.

The processor 602 then generates constraint equations or conditions corresponding to the constraints of the problem, which are stored together with the decision variable matrix data structure and coefficients matrix data structure in memory 604.

The processor 602 transforms the decision variable matrix data structure and the coefficients matrix data structure into a mixed-integer linear programming (MILP) formulated problem with a linear objective function and the constraint equations by applying matrix transformations. The processor 602 then maps the MILP formulated problem onto a quadratic unconstrained binary optimization (QUBO) by replacing all continuous variables in the linear objective function with a plurality of discrete binaries and encoding the constraint equations.

The processor 602 receives as inputs the decision variable matrix data structure, the coefficients matrix data structure, and the encoded constraint equations.

The processor 602 satisfies the objective function of the QUBO in a loop, until a equilibrium criterion is met. In the loop, the processor 602 computes an optimal allocation of the set of data objects to the set of parties by computing a global optimum result of the QUBO using a solver. Then, the processor 602 updates the values of the decision variable matrix data structure in computer memory 604 with the optimal allocation parameters to obtain the optimal allocation of the set of data objects to the set of parties.

The processor 602 can then extrapolate allocation parameters from the updated decision variable matrix data structure of the optimal allocation of the set of data objects to the set of parties. The user has the flexibility to choose the extrapolated allocation parameters to realize the optimal allocation of the set of data objects to the set of parties. The allocation parameters can be extrapolated from the optimal allocation and presented via the interface 606 for selection. For example, the interface 606 can present various allocation parameters that are equivalently optimal to the user for selection to produce an optimal allocation of the data objects to the parties. The allocation parameters can be practically implemented to be in the form of a vector or list of parameter values.

The allocation parameters can be transformed into transaction routing instruction data objects. The transaction routing instruction data objects are data messages that are generated and transmitted to execute allocation modification transactions.

An allocation tracking engine processor may be configured to periodically compare the allocation parameters against an actual allocation based on a polling or monitoring of the transaction receipts, and generate transaction instructions based on errors or differentials to approximate the identified allocation. This can include fractional purchases of assets, selling assets, swapping assets, among others. An example allocation tracker can, for example, automatically conduct trades in respect of cryptocurrency or blockchains by interfacing with blockchain nodes or exchange APIs and sending data messages with data payload instructions for transfers. The actual allocation and the target allocation can be persisted in a non-transitory computer readable storage medium and periodically tracked for error.

The memory 604 stores data for the QUBO transformation, the decision variable matrix data structure and the coefficients matrix data structure, along with data for parameters, objective functions, and the encoded constraints. The memory 604 stores instructions on non-transitory computer readable media for execution by the processor 602 to implement operations described herein.

In some embodiments, the processor 602 can extract the allocation parameters from the optimal allocation and store the allocation parameters in memory 604. In some embodiments, the processor 602 can transmit the allocation parameters to another device through network interface 608 to generate or produce an optimal allocation of similar data objects to parties based on the allocation parameters.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computing system configured for transforming a high complexity mixed-integer linear programming (MILP) subroutine having a large problem instance into a quadratic unconstrained binary optimization (QUBO) programming subroutine adapted for using quantum or quantum inspired approaches for optimizing allocation of a set of data objects to a set of parties with a plurality of constraints, the computing system comprising:
a computer processor coupled to non-transitory computer memory and data storage, the computer processor configured to:
initialize a decision variable matrix data structure containing a plurality of object-party allocation variable as elements, wherein each object-party allocation variable is a continuous variable representing an allocation score of the corresponding data object that is allocated to the corresponding party, wherein the decision variable matrix has a column for each data object, wherein the decision variable matrix has a row for each party;
construct a coefficients matrix data structure to store a plurality of tiers, wherein the coefficients matrix data structure has a column for each data object, wherein the coefficients matrix data structure has a row for each party, wherein each tier is a scalar value indicative of quality of the corresponding object-party allocation variable;
generate a plurality of constraint equations corresponding to the plurality of constraints;
transform the decision variable matrix data structure and the coefficients matrix data structure into the MILP programming subroutine with a linear objective function and the plurality of constraint equations;
map the MILP programming subroutine onto the QUBO programming subroutine by replacing all continuous variables in the linear objective function with a plurality of discrete binaries and encoding the plurality of constraint equations;
compute an optimized allocation of the set of data objects to the set of parties by solving the QUBO programming subroutine;
extrapolate, from the decision variable matrix data structure of the optimized allocation of the set of data objects to the set of parties, allocation parameters to realize the optimized allocation of the set of data objects to the set of parties, the allocation parameters being a vector or list of parameter values; and
generate, one or more data messages corresponding to electronic transaction requests to automatically shift allocation in accordance with the optimized allocation of the set of data objects.

2. The computing system of claim 1, wherein the set of data objects and set of parties are represented as a bipartite graph comprising two sets of nodes with weighted edges, the two sets of nodes representing the set of data objects and the set of parties.

3. The computing system of claim 1, wherein the computing system further includes an adaptive encoder configured to map individual constraint properties to either a balanced encoding approach or an unbalanced penalization approach, controlling a number of slack variables being used during constraint encoding into the QUBO programming subroutine.

4. The computing system of claim 1, wherein the computer processor is a noisy intermediate-scale quantum (NISQ) device processor using variational quantum algorithms (VQAs).

5. The computing system of claim 1, wherein the computer processor is a quantum computer processor using quantum annealing.

6. The computing system of claim 1, wherein the computer processor utilizes the QUBO programming subroutine with a digital or simulated annealing approach.

7. The computing system of claim 1, wherein encoding the plurality of constraint equations comprises using a plurality of balanced slack variables for penalization.

8. The computing system of claim 1, further comprising a selection circuit that is coupled to a MILP solver, the selection circuit configured to generate a computational starting point using the MILP solver, and then configured to solve the QUBO programming subroutine using the computational starting point as an initial condition.

9. The computing system of claim 1, wherein encoding the plurality of constraint equations comprises using an unbalanced penalization technique comprising creating a plurality of penalty terms, wherein a penalty term takes on a value dependent on violation of the corresponding constraint.

10. The computing system of claim 1, wherein the computer processor comprises a GPU with a plurality of tensor cores that is optimized for mixed-precision training in a machine learning model, the mixed-precision training enabling the GPU to compute a plurality of computer number precision formats.

11. A method for transforming a high complexity mixed-integer linear programming (MILP) subroutine having a large problem instance into a quadratic unconstrained binary optimization (QUBO) programming subroutine adapted for using quantum or quantum inspired approaches for optimizing allocation of a set of data objects to a set of parties with a plurality of constraints, the method comprising:
initializing a decision variable matrix data structure containing a plurality of object-party allocation variable as elements, wherein each object-party allocation variable is a continuous variable representing an allocation score of the corresponding data object that is allocated to the corresponding party, wherein the decision variable matrix has a column for each data object, wherein the decision variable matrix has a row for each party;
constructing a coefficients matrix data structure to store a plurality of tiers, wherein the coefficients matrix data structure has a column for each data object, wherein the coefficients matrix data structure has a row for each party, wherein each tier is a scalar value indicative of quality of the corresponding object-party allocation variable;
generating a plurality of constraint equations corresponding to the plurality of constraints;
transforming the decision variable matrix data structure and the coefficients matrix data structure into the MILP programming subroutine with a linear objective function and the plurality of constraint equations;
mapping the MILP programming subroutine onto the QUBO programming subroutine by replacing all continuous variables in the linear objective function with a plurality of discrete binaries and encoding the plurality of constraint equations;
determining an optimized allocation of the set of data objects to the set of parties by solving the QUBO programming subroutine;
extrapolating, from the decision variable matrix data structure of the optimized allocation of the set of data objects to the set of parties, allocation parameters to realize the optimized allocation of the set of data objects to the set of parties, the allocation parameters being a vector or list of parameter values; and
generating, one or more data messages corresponding to electronic transaction requests to automatically shift allocation in accordance with the optimized allocation of the set of data objects.

12. The method of claim 11, wherein the set of data objects and set of parties are represented as a bipartite graph comprising two sets of nodes with weighted edges, the two sets of nodes representing the set of data objects and the set of parties.

13. The method of claim 11, wherein the method further includes an adaptive encoder configured to map individual constraint properties to either a balanced encoding approach or an unbalanced penalization approach, controlling a number of slack variables being used during constraint encoding into the QUBO programming subroutine.

14. The method of claim 11, wherein the computer processor is a noisy intermediate-scale quantum (NISQ) device processor using variational quantum algorithms (VQAs).

15. The method of claim 11, wherein the method is conducted on a quantum computer processor using quantum annealing.

16. The method of claim 11, wherein the computer processor utilizes the QUBO programming subroutine with a digital or simulated annealing approach.

17. The method of claim 11, wherein encoding the plurality of constraint equations comprises using a plurality of balanced slack variables for penalization.

18. The method of claim 11, further comprising a selection circuit that is coupled to a MILP solver, the selection circuit configured to generate a computational starting point using the MILP solver, and then configured to solve the QUBO programming subroutine using the computational starting point as an initial condition.

19. The method of claim 11, wherein encoding the plurality of constraint equations comprises using an unbalanced penalization technique comprising creating a plurality of penalty terms, wherein a penalty term takes on a value dependent on violation of the corresponding constraint.

20. A non-transitory computer readable medium storing computer interpretable instruction, which when executed by a computer processor, cause the computer processor to perform a method for transforming a high complexity mixed-integer linear programming (MILP) subroutine having a large problem instance into a quadratic unconstrained binary optimization (QUBO) programming subroutine adapted for using quantum or quantum inspired approaches for optimizing allocation of a set of data objects to a set of parties with a plurality of constraints, the method comprising:
initializing a decision variable matrix data structure containing a plurality of object-party allocation variable as elements, wherein each object-party allocation variable is a continuous variable representing an allocation score of the corresponding data object that is allocated to the corresponding party, wherein the decision variable matrix has a column for each data object, wherein the decision variable matrix has a row for each party;
constructing a coefficients matrix data structure to store a plurality of tiers, wherein the coefficients matrix data structure has a column for each data object, wherein the coefficients matrix data structure has a row for each party, wherein each tier is a scalar value indicative of quality of the corresponding object-party allocation variable;
generating a plurality of constraint equations corresponding to the plurality of constraints;
transforming the decision variable matrix data structure and the coefficients matrix data structure into the MILP programming subroutine with a linear objective function and the plurality of constraint equations;
mapping the MILP programming subroutine onto the QUBO programming subroutine by replacing all continuous variables in the linear objective function with a plurality of discrete binaries and encoding the plurality of constraint equations;
determining an optimized allocation of the set of data objects to the set of parties by solving the QUBO programming subroutine;
extrapolating, from the decision variable matrix data structure of the optimized allocation of the set of data objects to the set of parties, allocation parameters to realize the optimized allocation of the set of data objects to the set of parties, the allocation parameters being a vector or list of parameter values; and
generating, one or more data messages corresponding to electronic transaction requests to automatically shift allocation in accordance with the optimized allocation of the set of data objects.
